(19) United States
(12) Patent Application Publication
(10) Pub. No.: US 2011/0219243 A1
(43) Pub. Date: Sep. 8, 2011

(54) Supplying Power To A Computer System During A Holdup Time

(76) Inventors: Daniel Humphrey, Houston, TX (US); Mohamed Amin Bemat, Cypress, TX (US); Mark Isaqani Bello Rivera, Cypress, TX (US)

(21) Appl. No.: 12/715,958

(22) Filed: Mar. 2, 2010

(51) Int. Cl. G06F 1/00

(52) U.S. Cl. 713/300; 714/24

(57) ABSTRACT

A method for powering a computer system is disclosed. The method supplies power to a power distribution system in the computer using power components in the power supply when the power supply in the computer system is receiving AC power. When the AC power to the power supply is interrupted, at least one component in the computer system coupled to the power distribution system is powered down and power to the power distribution system is supplied using an energy storage device in the power supply for a holdup time H.

### BACKGROUND

Holdup time for a power supply unit is defined as the amount of time, typically measured in milliseconds, that the power supply unit (PSU) can maintain output within a specified voltage range after a loss of input power. Many power supplies use a large bulk capacitor to provide the specified holdup time. The large bulk capacitor may be a costly component of the power supply.

### BRIEF DESCRIPTION OF THE DRAWINGS

FIG. 1 is a block diagram of a computer system 100 in an example embodiment of the invention.

FIG. 2a is a block diagram of a power supply 200 when it is receiving AC power, in an example embodiment of the invention.

FIG. 2b is a block diagram of a power supply 200 when it is not receiving AC power, in an example embodiment of the invention.

### DETAILED DESCRIPTION

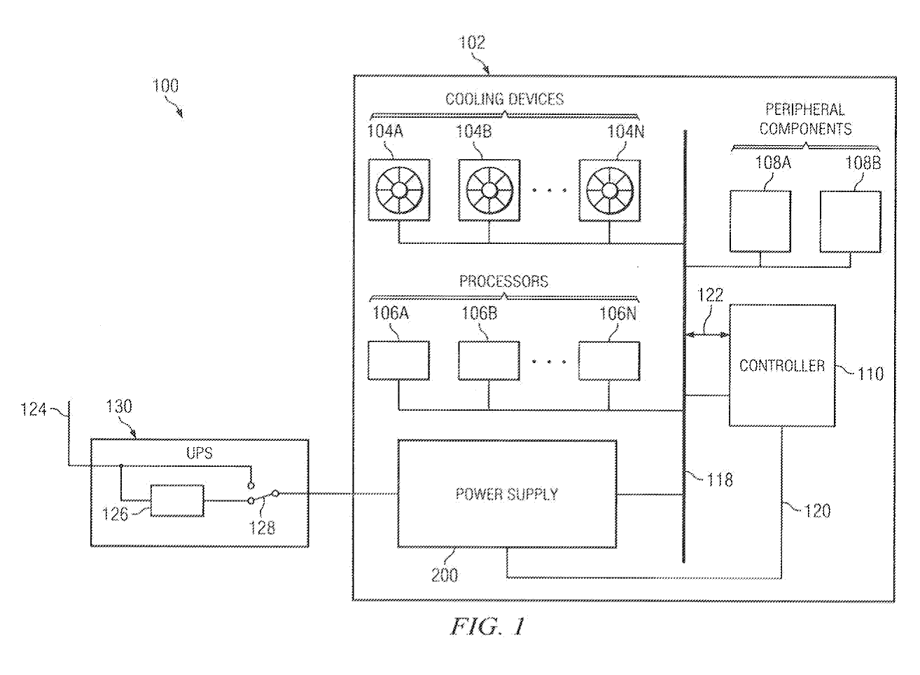

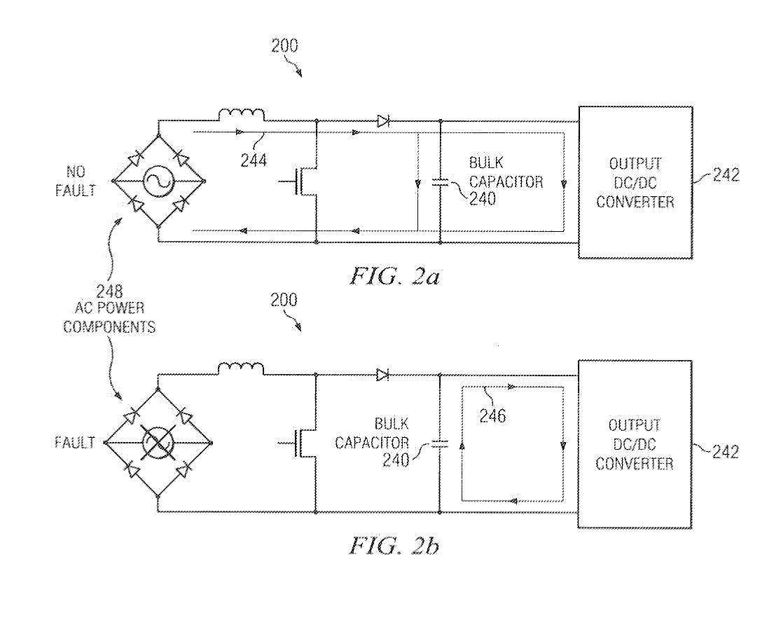

FIG. 1-2 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is a block diagram of a computer system 100 in an example embodiment of the invention. Computer system 100 comprises computer 102 and an uninterruptible power supply (UPS) 130. Computer 102 comprises at least one power supply 200, one or more cooling devices 104a-104n, one or more processors 106a-106n, one or more peripheral components 108a-108b, a controller 110 and a power distribution system 118. Computer 102 may be a personal computer (PC), a server, a blade system, a mainframe or the like. Cooling devices 104a-104n may be fans for use in an air cooled system, pumps for use in a liquid cooled system, or a combination of fans and pumps. Processors 106a-106n may be CPU's, application specific circuits (ASIC), blades, or the like. Peripheral components 108a-108n may be memory components, storage components, display components, I/O components, graphic components, or the like.

Power supply 200 is coupled to, and supplies power to power distribution system 118. Power distribution system 118 couples to, and supplies power to, one or more cooling devices 104a-104n, one or more processors 106a-106n, one or more peripheral components 108a-108b, and controller 110. Controller 110 sends control signals to power distribution system 118 across control link 122. Using control link 122, controller 110 can enable or disable power to different areas of power distribution system. For example, controller can enable or disable the power to one or more of the cooling devices 104a-104n and/or one or more peripheral components 108a-108n. Controller 110 is shown as a separate component in FIG. 1. In other example embodiments, controller 110 may be integrated into one of the one or more processors 106a-106n.

Power supply 200 inside computer 102 is coupled to uninterruptible power supply (UPS) 130. Uninterruptible power supply (UPS) 130 is coupled to AC power source 124. Uninterruptible power supply (UPS) 130 comprises alternate power source 126 and switch 128. Alternate power source may comprise energy storage devices and/or a generator. During normal operations, switch 128 couples AC power source 124 to power supply 200. When power from AC power source is interrupted, switch 128 is activated and couples alternate power source 126 to power supply 200. Switching from interrupted AC power source 124 to alternate power source 126 may take a finite amount of time. During the time it takes to make the switch from interrupted AC power source 124 to alternate power source 126, the AC power flowing into power supply 200 may be reduced or completely interrupted.

FIGS. 2a and 2b are block diagrams of power supply 200. Power supply 200 comprises AC power components 248, energy storage device 240 and DC/DC converter 242. Energy storage device 240 is typically a bulk capacitor, but may be other types of energy storage devices. FIG. 2a shows power supply 200 when it is receiving AC power. FIG. 2b shows power supply 200 when the AC power has been interrupted. During normal operation (see FIG. 2a), when power supply is receiving AC power, current is flowing from AC power components 248 into energy storage device 240, and into DC/DC converter (see arrow 244). When the AC power flowing into power supply 200 is reduced or interrupted (see FIG. 2b), current flows out of energy storage device 240 into DC/DC converter (see arrow 246). DC/DC converter 240 outputs DC power to power distribution system 118.

Energy storage device 240 typically supplies power for a short period of time, typically referred to as the holdup time. Holdup time is defined as the amount of time, typically measured in milliseconds, that a power supply can maintain output within a specified voltage range after a loss of input power. The holdup time is dependent on the load applied to energy storage device 240 by the power distribution system and the size of energy storage device 240. The holdup time is typically set such that the holdup time is larger than the amount of time required by the uninterruptible power supply (UPS) 130 to switch to its alternate power source 126 (typically called the ride through time). In systems that do not contain a UPS, the holdup time may be set to allow for the orderly shutdown of the computer systems.

Power supply 200 has logic that detects when power is being drawn from energy storage device 240 or logic that detects when the AC power into power supply is interrupted. When power supply 200 detects one of these two conditions, power supply 200 sends a signal along line 120 to controller 110. When controller receives a signal that indicates energy is flowing from energy storage device 240, controller will power down one or more of the cooling devices 104a-104n by disabling the power to one or more of the cooling devices 104a-104n. In another example embodiment of the invention, controller may power down one or more devices by sending control signals to the devices, instead of disabling the power to the devices. The devices would turn themselves off in response to the control signals. By powering down one or more of the cooling devices, the load on energy storage device 240 is reduced. By reducing the load on energy storage device 240, the holdup time is increased for a given amount of energy storage capacity in energy storage device 240. The increase in the holdup time may be by as much as 20%.

Once AC power has been re-established into power supply 200 a signal is sent to controller on line 120 that indicates that power is no longer being drawn from energy storage device 240. When controller receives this signal, controller may re-enable power back to cooling devices 104a-104n or send a control signal to the cooling devices that indicates that the devices can turn themselves back on.

By reducing the load on energy storage device 240 from a full load (Lf) to a partial load (Lp) during the holdup time, the amount of energy storage capacity in energy storage device 240, for a give holdup time, has been reduced. By reducing the required energy storage capacity in energy storage device 240, the size (and therefore the cost) of the bulk capacitor can be reduced. In one example embodiment of the invention the partial load (Lp) is equal to the full load (Lf) minus a component load Lc. In one example embodiment of the invention the component load Lc is the load from the cooling devices (Lcd). Powering down the cooling devices for a period of milliseconds typically will not impact system performance. In some example embodiments of the invention, controller 110 may power down other devices, in addition to, or instead of, cooling devices 104a-104n when controller receives the signal from power supply 200. In one example embodiment of the invention, other devices may include for example, display devices, input devices, or the like. The controller can power down a device by either disabling power to the device, or by turning the device off.

What is claimed is:

1. A method of powering a computer system comprising:
when a power supply in the computer system is receiving AC power:
supplying power to a power distribution system from the power supply while charging an energy storage device inside the power supply;
when the AC power to the power supply is interrupted:
supplying power to the power distribution system using the energy storage device in the power supply for a holdup time H, and powering down at least one component in the computer system coupled to the power distribution system.

2. The method of claim 1, wherein the at least one component is a cooling device.

3. The method of claim 1, wherein powering down the at least one component is done by selecting one method from the following group of methods: disabling power to the at least one device, or sending a control signal to the at least one device wherein the device turns itself off in response to the control signal.

4. The method of claim 1, further comprising:
when the AC power to the power supply is restored:
supplying power to the power distribution system from the power supply while charging the energy storage device inside the power supply and powering back up the at least one component in the computer system.

5. The method of claim 1, further comprising:
when the AC power to the power supply is interrupted:
supplying power from the energy storage device to at least one processor.

6. The method of claim 1, wherein the energy storage device is a bulk capacitor.

7. The method of claim 1, wherein the holdup time H is determined for a partial load Lp and the partial load (Lp) is equal to a full load (Lf) minus a component load (Lc).

8. A computer system, comprising:
at least one power supply coupled to, and configured to supply power to, a power distribution system;
power distribution system is coupled to, and configured to supply power to, at least one component, and a controller;
power supply comprises:
DC/DC converter and energy storage device, wherein energy storage device is sized to provide a holdup time H when under a partial load Lp;
when power supply is receiving AC power:
energy storage device is charging and does not supply energy to power distribution system;
when AC power flowing into power supply is interrupted:
energy storage device supplies power to power distribution system;
power supply is coupled to, and configured to send signals to controller, wherein the signals indicate when energy storage device is supplying power to power distribution system;
controller is coupled to, and configured to send control signals to power distribution system, wherein the control signals enable/disable power to the at least one component.

9. The computer system of claim 8, wherein the partial load (Lp) is equal to a lull load (Lf) minus a component load (Lc).

10. The computer system of claim 9, wherein the at least one component is a cooling device and the component load (Lc) is equal to a load from the cooling devices (Lcd).

11. The computer system of claim 8, further comprising:
a first plurality of components wherein the first plurality of components are cooling devices;
a second plurality of components wherein the second plurality of components are processors;
a third plurality of components wherein the third plurality of components are peripheral components.

12. The computer system of claim 11, wherein the partial load (Lp) is equal to a full load (Lf) minus a total load from the plurality of cooling devices (Lcd).

13. The computer system of claim 11, wherein at least one of the plurality of cooling devices is a fan.

14. The computer system of claim 8, wherein energy storage device is a bulk capacitor.

15. A computer system, comprising:
at least one power supply coupled to, and configured to supply power to, a power distribution system;
power distribution system is coupled to, and configured to supply power to, at least one component, and a controller;
power supply comprises:
DC/DC converter and energy storage device, wherein energy storage device is sized to provide a holdup time H when under a partial load Lp;
when power supply is receiving AC power:
energy storage device is charging and does not supply energy to power distribution system;
when AC power flowing into power supply is interrupted:
energy storage device supplies power to power distribution system;
power supply is coupled to, and configured to send signals to controller, wherein the signals indicate when energy storage device is supplying power to power distribution system;
controller is coupled to, and configured to send a control signal to the at least one component, wherein the at least one component powers down in response to the control signal.
